(19) United States
(12) Patent Application Publication
(10) Pub. No.: US 2021/0221599 A1
(43) Pub. Date: Jul. 22, 2021

(54) POLYMERIC BAG

(71) Applicant: Poly-America, L.P., Grand Prairie, TX (US)

(72) Inventor: Brad A. Cobler, Irving, TX (US)

(21) Appl. No.: 16/744,453

(22) Filed: Jan. 16, 2020

(51) Int. Cl. B65D 81/36; B65D 30/20

(52) U.S. Cl. CPC B65D 81/363; B31B 2155/00; B65D 31/10

(57) ABSTRACT

The present invention relates to improvements for T-shirt bags formed from a side gusseted tube of polymeric film. In particular, the embodiments of the invention provide means for reinforcing the handle seals of a T-shirt bag while limiting the amount of scrap material generated in the manufacturing process. In one embodiment, at least two seals are provided for forming each of the opposing two handles of the T-shirt bag. In further embodiments, a curved lower seal is provided as part of each handle's seal. In additional embodiments, a single seal of a continuous area is provided for each handle.

### CROSS-REFERENCE TO RELATED APPLICATIONS

Not applicable.

### BACKGROUND OF THE INVENTION

### 1. Field of the Invention

The present invention relates to an improved bag constructed from polymeric film. Particularly, the present invention relates to side gusseted bags commonly referred to as T-shirt bags.

### 2. Description of the Related Art

Thermoplastic films are used in a variety of applications. For example, thermoplastic films are used in sheet form for applications such as drop cloths, vapor barriers, and protective covers. Thermoplastic films can also be converted into plastic bags, which may be used in a myriad of applications. The present invention is particularly useful for bags constructed from thermoplastic film.

Polymeric bags are ubiquitous in modern society and are available in countless combinations of varying capacities, thicknesses, dimensions, and colors. The bags are available for numerous applications including typical consumer applications such as long-term storage, food storage, shopping, and trash collection. Like many other consumer products, increased demand and new technology have driven innovations in polymeric bags improving the utility and performance of such bags. The present invention is an innovation of particular relevance to side gusseted bags commonly referred to as T-shirt bags.

Polymeric bags are manufactured from polymeric film produced using one of several manufacturing techniques well-known in the art. The two most common methods for manufacture of polymeric films are blown-film extrusion and cast-film extrusion. In blown-film extrusion, the resulting film is tubular while cast-film extrusion produces a generally planar film. The present invention is generally applicable to bags manufactured from a blown-film extrusion process resulting in tubular film stock.

In blown film extrusion, polymeric resin is fed into an extruder where an extrusion screw pushes the resin through the extruder. The extrusion screw compresses the resin, heating the resin into a molten state under high pressure. The molten, pressurized resin is fed through a blown film extrusion die having an annular opening. As the molten material is pushed into and through the extrusion die, a polymeric film tube emerges from the outlet of the extrusion die.

The polymeric film tube is blown or expanded to a larger diameter by providing a volume of air within the interior of the polymeric film tube. The combination of the volume of air and the polymeric film tube is commonly referred to as a bubble between the extrusion die and a set of nip rollers. As the polymeric film tube cools travelling upward toward the nip rollers, the polymeric film tube solidifies from a molten state to a solid state after it expands to its final diameter and thickness. Once the polymeric film tube is completely solidified, it passes through the set of nip rollers and is collapsed into a collapsed polymeric tube, also referred to as a collapsed bubble.

T-shirt bags are commonly formed by placing partial opposing side gussets in a tubular length of polymeric film. Once the gussets are created, pairs of closely spaced transverse seals are placed on the gusseted tube at predetermined lengths to define bottom seals and top handle seals for each bag. Once the seals are placed on the tube, the tube can be cut between the closely spaced pairs of seals to form a plurality of bag sections. The bag sections can then be stacked. The stacked bag sections then commonly have an opening and opposing side handles die cut out of one side of the stack of bags between the two opposing partial side gussets.

U.S. Pat. No. 6,461,041 (the '041 patent), filed Nov. 7, 2000 and hereby incorporated by reference, is directed to a means of reinforcing the bottom seal of a T-shirt bag. The '041 patent discloses that the weakest area of a common T-shirt bag are the junctions of the bottom seal. Therefore, the '041 patent teaches use of an additional strip of film to reinforce this area of the bag.

It is further known in the art to use a thin strip of material to reinforce the top seals of the bag which define the two opposing side handles. However, use of this strip of film leads to a considerable inefficient use of material because much of the material is cut away from the bag as scrap when the top opening and handles are die cut into the bag. Furthermore, use of the reinforcement strip for the T-shirt bag's handles typically fails to provide any reinforcement to the outer edges of the handle seals, due to the desire to limit material usage.

In consideration of the shortcomings of the above discussed prior art, it would be desirable to provide a T-shirt bag with improved handle strength that more efficiently utilizes material. The present invention represents a novel solution to address this need.

### SUMMARY OF THE INVENTION

According to one embodiment of the present invention, a bag is formed from a gusseted tube of polymeric film. The bag can comprise a front panel and a rear panel and each panel can have an upper edge and a bottom edge. The front and rear panel can be joined by a bottom seal adjacent to the bottom edge. The bag can further comprise a first side gusset and an opposing second side gusset and each side gusset can be between and on opposing sides of the front and rear panels. Each side gusset can have an inner fold and two outer folds and each side gusset can further comprise two layers between the two outer folds, the two layers defined by the inner fold. The bag can further comprise opposing first and second handles adjacent to the upper edges of the front and rear panels. The first and second handles can be separated from each other by a bag cutout. The first handle can comprise the front panel, the rear panel, the first side gusset, an upper handle seal and a lower handle seal. The upper and lower handle seals can seal together the front panel, the rear panel, and the first side gusset. The upper and lower handle seals can extend from a first side to a second side of the first handle. Additionally, the upper and lower handle seals can be separated by a width of unsealed film.

In certain embodiments of the present invention, the upper and lower handle seals can be generally straight. Additionally, the upper and lower handle seals can be parallel with each other. The upper and lower handle seals can be separated from each other by at least ⅛ of an inch and by no more than one inch. The lower handle seal can be arcuate and have a radius of curvature centered above the upper handle seal. Also, the lower and upper handle seals can comprise heat seals and the lower handle seal can be formed at a lower temperature or at a shorter dwell time than the upper handle seal.

In a further embodiment of the present invention, a bag is formed from a gusseted tube of polymeric film. The bag can comprise a front panel and a rear panel and each panel can have an upper edge and a bottom edge. The front and rear panel can be joined by a bottom seal adjacent to the bottom edge, a first side gusset and a second side gusset. Each side gusset can be between and on opposing sides of the front and rear panels and each side gusset can comprise an inner fold and two outer folds. Each side gusset can further comprise two layers between the two outer folds. The bag can also comprise opposing first and second handles along the upper edge and the first and second handles can be separated from each other by a bag cutout. The first handle can comprise the front panel, the rear panel, and the first side gusset. A first handle seal can seal together the front panel, the rear panel, and the first side gusset. The first handle seal can comprise upper and lower opposing seal edges and the upper seal edge can be generally parallel and proximate to the upper edge. The lower seal edge can have at least one arcuate surface and the first handle seal can extend continuously from the upper seal edge to the lower seal edge.

In at least certain embodiments of the invention, the lower seal edge can curve outward from the upper seal edge such that the lower seal edge is convex. The lower seal edge can also have a single constant radius extending from a first side to an opposing second side of the first handle and the single constant radius can have a length of at least one-half a width of the first handle. Additionally, a seal void can be defined within the first handle seal. The seal void can comprise an area where the front panel, the rear panel, and the first side gusset are not sealed to each other. An upper edge of the seal void can be parallel to the upper seal edge and a lower edge of the seal void can be parallel to the upper seal edge. Furthermore, the first handle seal can comprise a heat seal and the heat seal can be formed at a lower temperature at a location proximate to the lower edge than at a location proximate to the upper edge. Additionally, the entire area defined between the upper and lower seal edges can be a single continuous seal.

It is contemplated that the present invention may be utilized in ways that are not fully described or set forth herein. The present invention is intended to encompass these additional uses to the extent such uses are not contradicted by the appended claims. Therefore, the present invention should be given the broadest reasonable interpretation in view of the present disclosure, the accompanying figures, and the appended claims.

### BRIEF DESCRIPTION OF THE RELATED DRAWINGS

A full and complete understanding of the present invention may be obtained by reference to the detailed description of the present invention and the preferred embodiments when viewed with reference to the accompanying drawings. The drawings can be briefly described as follows.

FIG. 1 provides a front view of prior art T-shirt bag 100.

FIG. 2 provides a cross-sectional view of bag 100 taken along line A-A of FIG. 1.

FIG. 3 provides a cross-sectional view of bag 100 taken along line B-B of FIG. 1.

FIG. 4 provides a side view of bag 100.

FIG. 5 provides a front perspective view of bag 100 with bag 100 filled with contents.

FIG. 6 provides a front view of prior art bag 600.

FIG. 7 provides a front view of bag 700, a first embodiment of the present invention.

FIG. 8 provides a front view of bag 800, a second embodiment of the present invention.

FIG. 9 provides a front view of bag 900, a third embodiment of the present invention.

FIG. 10 provides a front view of bag 1000, a fourth embodiment of the present invention.

### DETAILED DESCRIPTION OF THE INVENTION

The present disclosure illustrates one or more preferred embodiments of the present invention. It is not intended to provide an illustration or encompass all embodiments contemplated by the present invention. In view of the disclosure of the present invention contained herein, a person having ordinary skill in the art will recognize that innumerable modifications and insubstantial changes may be incorporated or otherwise included within the present invention without diverging from the spirit of the invention. Therefore, it is understood that the present invention is not limited to those embodiments disclosed herein. The appended claims are intended to more fully and accurately encompass the invention to the fullest extent possible, but it is fully appreciated that certain limitations on the use of particular terms is not intended to conclusively limit the scope of protection.

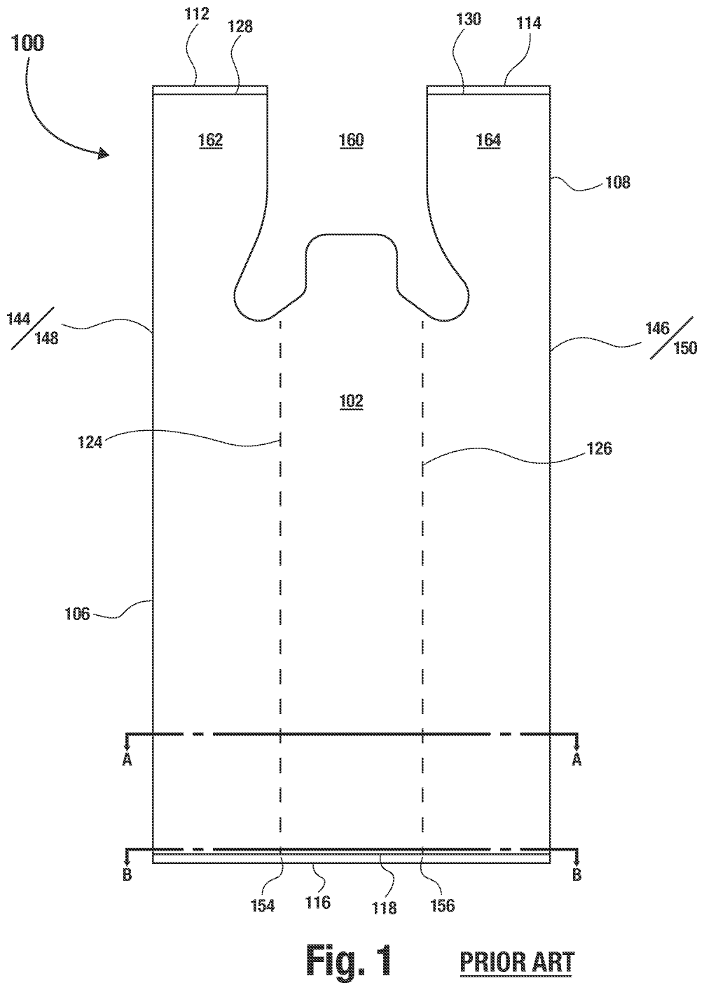

Prior art T-shirt bag 100 is shown by FIGS. 1-4 having a first panel 102 and a second panel 104. The two panels 102 and 104 are joined together at a first side 106 by a first side gusset 148, at a second side 108 by a second side gusset 150, adjacent to bottom edge 116 by bottom seal 118, and adjacent to top edges 112 and 114 by first and second handle seals 128 and 130. FIG. 1 further shows bag 100 having a pair of opposing handles 162 and 164. Handles 162 and 164 are separated by cutout region 160. As is known in the art, handles 162 and 164 can be formed by cutting out cutout region 160 from the blank that forms bag 100.

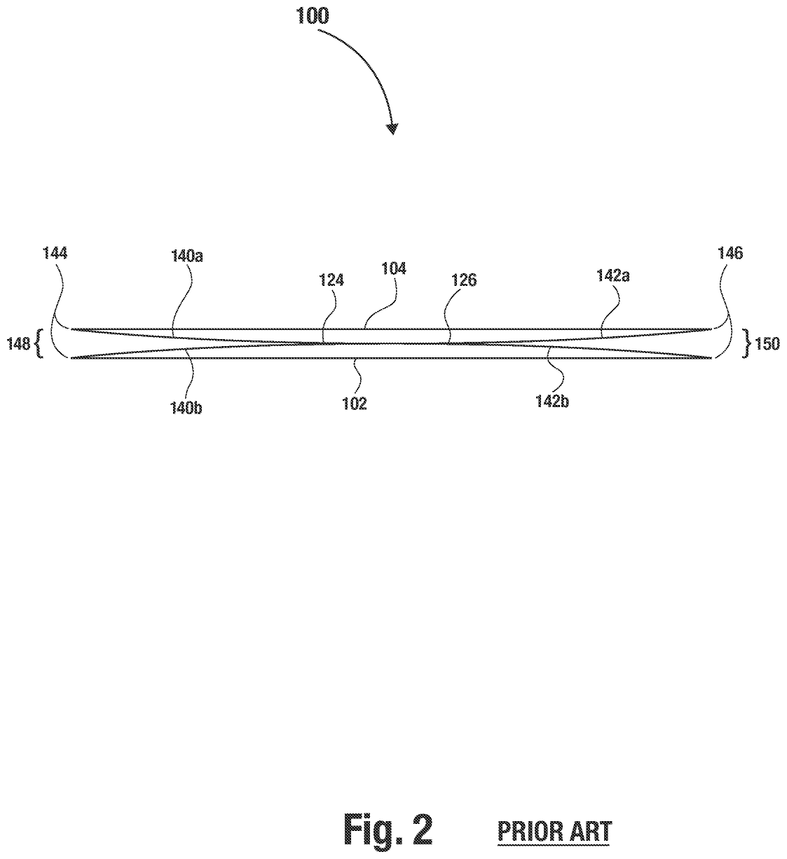

FIG. 2, a cross section view of bag 100 shown in FIG. 1, shows first side gusset 148 having a pair of outer folds 144 and inner fold 124. FIG. 2 further shows second side gusset 150 having a pair of outer folds 146 and inner fold 126. Also shown by FIG. 2 is side gusset 148 having two layers of film 140a and 140b located between outer folds 144. Additionally, side gusset 150 is shown having two layers of film 142a and 142b between outer folds 146.

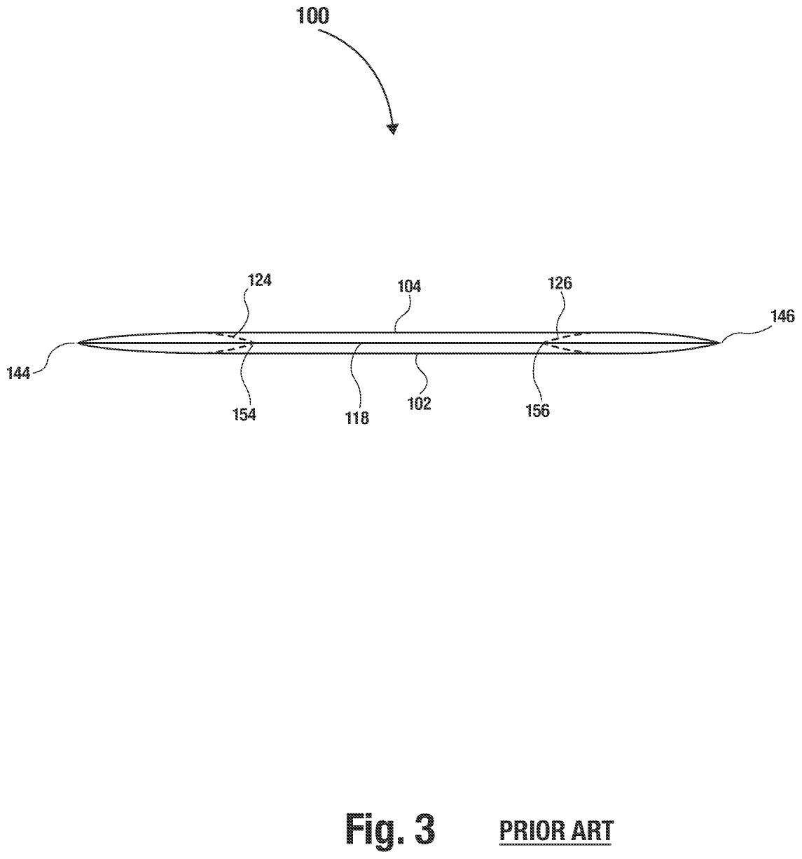

FIG. 3 shows a cross section of bag 100 where bottom seal 118 seals together front and rear panels 102 and 104. Bottom seal 118 merges together outer folds 144 and 146 at opposing sides of bag 100. Bottom seal 118 also seals together inner folds 124 and 126 at gusset/seal junction points 154 and 156. At these two junction points 154 and 156, the bottom seal 118 has a sudden transition from sealing together four layers of film to two layers of film. Due to this transition and the amount of stress placed on these junction points 154 and 156 being transferred from handles 162 and 164, junction points 154 and 156 are prone to fail in an unreinforced T-shirt bag. Junction points 154 and 156 typically fail by tearing, wherein the tear propagates and the contents of the bag can then spill from the bag.

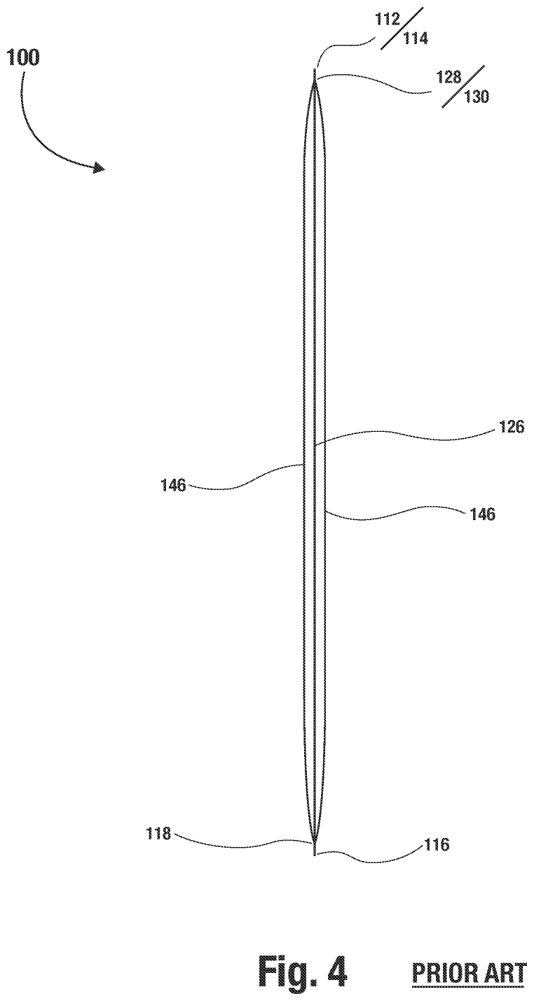

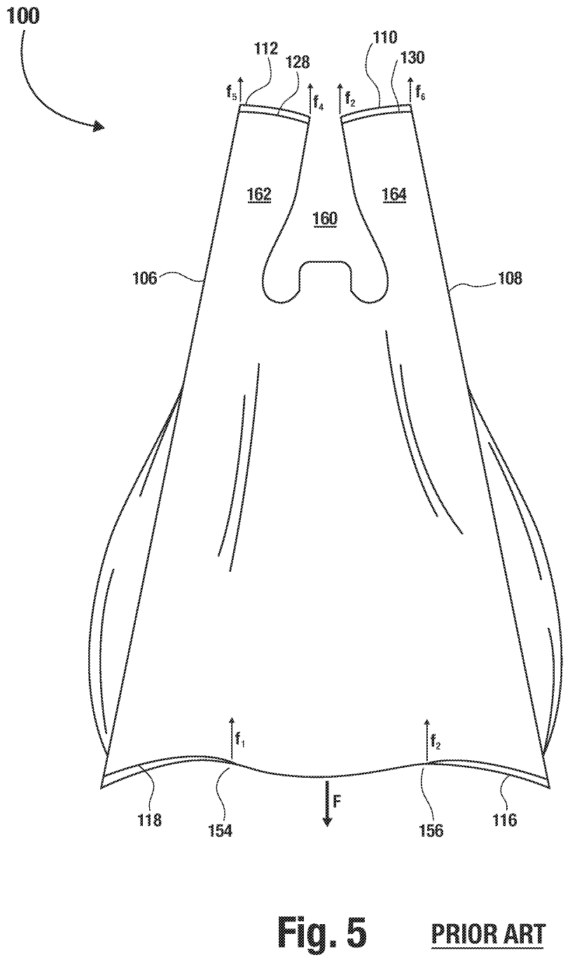

FIG. 4 shows a side view of bag 100 with the features as discussed above. FIG. 5 illustrates bag 100 loaded with goods. As illustrated by FIG. 5, force F of goods in bag 100 causes stress concentrations at junction points 154 and 156, indicated by f₁ and f₂. Load F is also known to cause stress concentrations at the inside edges of handles 162 and 164, indicated by f₃ and f₄, and at outside edge of handles 162 and 164, indicated by f₅ and f₆.

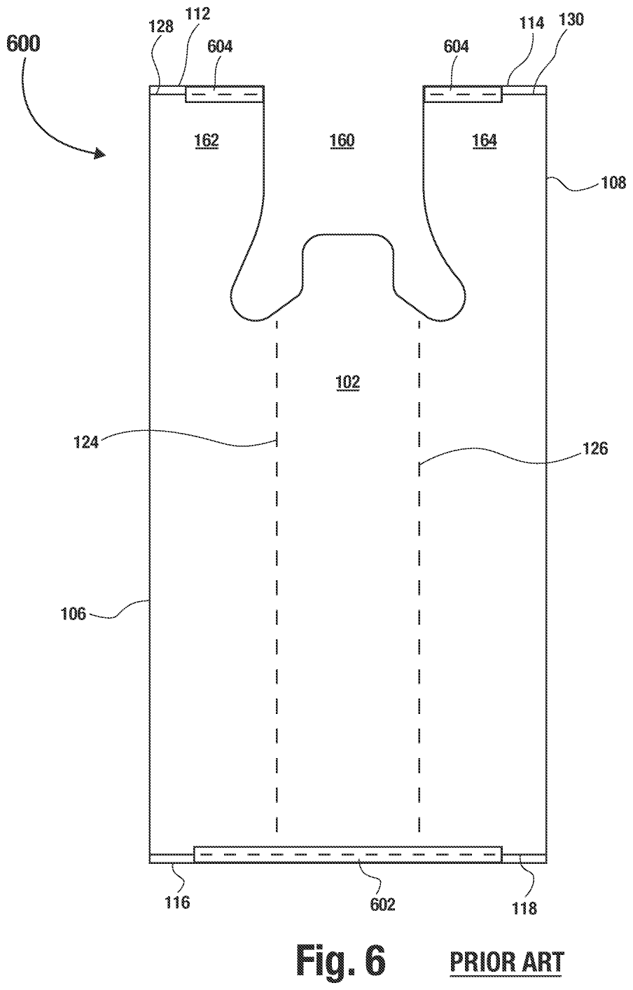

FIG. 6 shows prior art reinforced T-shirt bag 600. Bag 600 shares the same structure as bag 100 of FIGS. 1-5 with the addition of bottom seal reinforcement 602 and handle reinforcements 604 along top edges 112 and 114 of bag 600. It is known to use tape of polymeric film for reinforcements 602 and 604. Reinforcements 602 and 604 can be applied to bag 600 with the use of heat seals, and can be sealed to the bag at the same time bottom seal 118 and handle seals 128 and 130 are formed on bag 600. Reinforcements 602 and 604 can be applied to both panels 102 and 104, but are typically only applied to one of the two panels.

Bottom seal reinforcement 602 provides the necessary strength to bottom seal 118 to significantly reduce or eliminate failures at junction points 154 and 156 (as shown in FIG. 3) and handle reinforcements 604 provides the necessary strength to handle seals 128 and 130 to significantly reduce or eliminate failures along handle seals 128 and 130 adjacent to and at the inside edge of handles 162 and 164. However, reinforcements 604 as shown fail to provide any reinforcement adjacent to or at outer edges of handles 162 and 164.

As shown by FIG. 6, upper reinforcement film 204 is split into two sections between the two handles 162 and 164. Reinforcement 204 is typically applied as a single continuous piece of tape and then cut out with cutout region 160 during the manufacturing process. Due to this process, much of the material used to make reinforcement 204 results in scrap. The present invention addresses this inefficiency by providing alternate means of reinforcing handles seals 128 and 130. The present invention also provides for reinforcing of outer edges of handle seals 128 and 130, in contrast to the prior art.

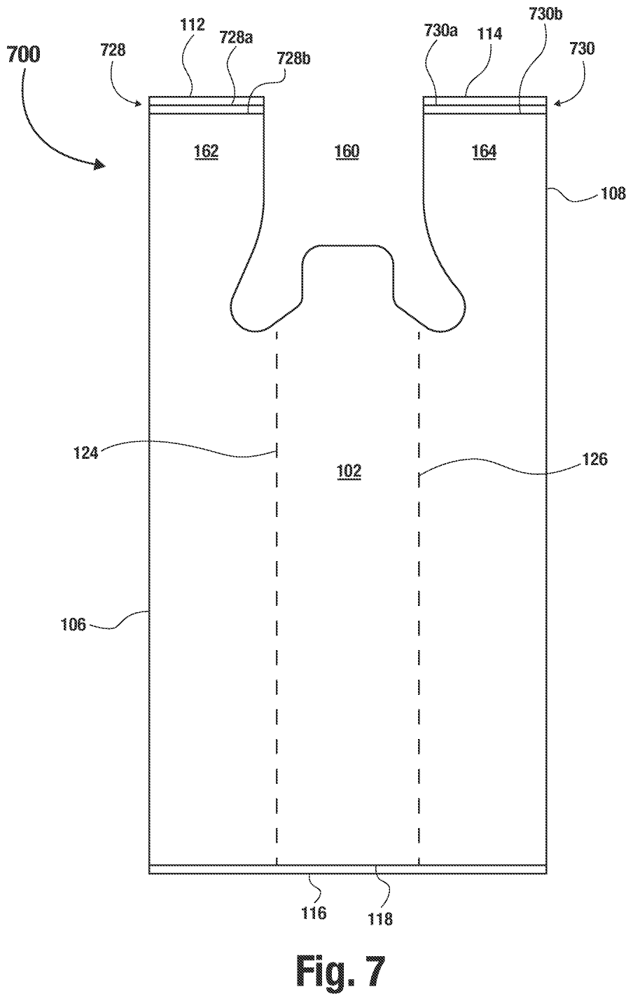

FIG. 7 shows bag 700, a first embodiment of the present invention. Bag 700 shares the same structure with bag 100 except for handles seals 128 and 130. Rather than a single handle seal at each handle 162 and 164, bag 700 has two seals, an upper and a lower seal, at each handle. First handle 162 is shown having an upper handle seal 728a and a lower handle seal 728b. Second handle 164 is shown having an upper handle seal 730a and a lower handle seal 730b. Each of the handle seals, 728a, 728b, 730a, and 730b are shown extending continuously from a first side to as second side of its corresponding handle 162 or 164.

Such an arrangement of dual handle seals provides for redundancy such that if lower handles seals 728b and 730b fail, upper handle seals 728a and 730a can still maintain the integrity of handles 162 and 164. Additionally, having dual seals for each handle seal 728 and 730 allows the two seals at each handle 162 and 164 to share the load so that less stress is imparted to each handle seal and thus the risk of any one of the seals 728a, 728b, 730a and 730b from failing is reduced.

In certain embodiments, seals 728a, 728b, 730a and 730b can be made via heat seals to weld the layers of film together. In further embodiments, upper handle seals 728a and 730a can be formed at a different temperature and/or at a different dwell time than lower handle seals 730a and 730b. For instance, lower seals 730a and 730b can be made at a lower temperature and/or at shorter dwell time.

Such conditions as described above can result in upper handle seals 728a and 730a having a greater seal strength than lower handle seals 728b and 730b. Nonetheless, in certain circumstances, lower seals 728b and 730b being made weaker than the upper seals may be advantageous. For instance, if variations in manufacturing conditions allow for over-sealing on upper seals 728a and 730a, such that the upper seal burns through due to excess sealing temperatures or dwell times, lower seals 728b and 730b can still be in the appropriate temperature range for proper sealing because lower seals 728b and 730b are made at a lower temperature and/or shorter dwell time than upper seals 728a and 730a. Thus, such an arrangement can result in each handles 162 and 164 having at least one proper seal.

In at least certain embodiments, each seal line of each of the handle seals 728a, 728b, 730a, and 730b can have a thickness from about 1/16 to about ⅛ of an inch. Therefore, to ensure that there is separation between each upper and lower seal, upper and lower seals for each handle 162 and 164 can be separated from each other by at least ⅛ of an inch. Furthermore, for at least certain embodiments, the maximum separation between upper and lower seals can be no more than an inch so that user access to bag 700 is not unnecessarily impeded while avoiding excessive usage of material in the construction of bag 700.

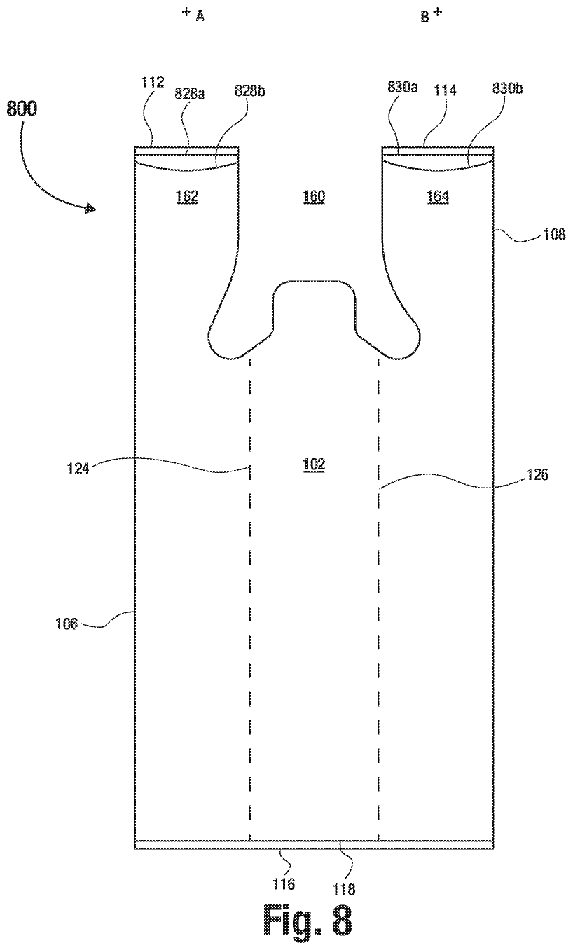

Shown in FIG. 8 is bag 800, a further embodiment of the present invention. As with bag 700, bag 800 has upper and lower seals for each handle 162 and 164. However, lower seals 828b and 830b of bag 800 are arcuate, while in at least certain embodiments, uppers seals 828a and 830a of bag remain straight and generally parallel with upper edges 112 and 114. As shown in FIG. 8, lower seals 828b and 830b have a radius of curvature centered above upper edges 112 and 114 of handles 162 and 164. Additionally, the radius of curvature of seals 828b and 830b of bag 800 exceeds the width of either handle 162 and 164 of bag 800. As shown, each radius of curvature of lower handle seals 828b and 830b is centered between opposing sides of its corresponding handle 162 or 164. However, in further embodiments, the radius of curvature may be offset from the center of corresponding handle 162 or 164. Additionally, in certain embodiments, each radius of curvature may be less than a width of the corresponding handle 162 or 164.

In at least certain embodiments, the minimum distance between upper and lower handles seals of handle 162 or 164 can be at least 1/16 of the width of the handle. In the same embodiment, the distance between the center of one of the handle's lower seals and the center of one of the handle's upper seals can be about ⅛ of the width of one of the handles 162 or 164 of bag 800. At least for certain sizes of T-shirt bags and as a non-limiting example, the shortest distance between upper and lower handle seals of a handle of bag 800 can be about ⅛ of an inch and the height between the center of the upper and lower handle seals can be at least ¼ of an inch. These distances, however, can vary considerably depending upon the overall size of T-shirt bag 800.

Bag 800 having lower handle seals 828b and 830b as shown is advantageous by relocating the stress concentrations from the inside and/or outside edges of handles 162 and 164 to the center of handles 162 and 164. With such a curvature, a user's hands are likely to make greater contact with the center of seals 828b and 830b; thus the center of each handle 162 and 164 will carry a greater amount of the load of bag 800 than would otherwise. Hence, a tear is less likely to begin at either side of either of the bag handles 162 and 164 with the center of handles 162 and 164 inherently able to carry a greater load without failing. In regards to lower handles seals 828b and 830b having a relatively long radius of curvature, such as shown in FIG. 8, this can be advantageous so that an excessive amount of the load of bag 800 is not carried by the center of handles 162 and 164 so as to avoid excessive stress concentrations.

As discussed in regards to bag 700, in certain embodiments, upper handle seals 828a and 830a can be formed at a different temperature and/or at a different dwell time than lower handle seals 830a and 830b. For instance, lower seals 830a and 830b can be made at a lower temperature and/or at shorter dwell time. Such conditions can result in upper handle seals 828a and 830a having a greater seal strength than lower handle seals 828b and 830b. The advantages for such a configuration as discussed above in regards to bag 700 can also be applicable to bag 800.

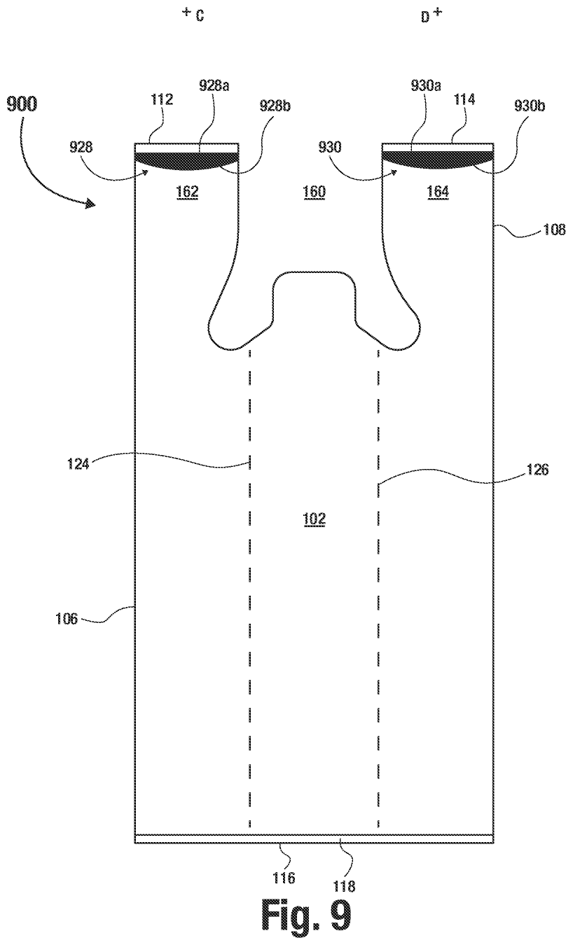

Now shown in FIG. 9 is bag 900, a further embodiment of the present invention. Bag 900 has a similar structure to bag 800 of FIG. 8, but rather than two separate seals for each handle seal 828 and 830, bag 900 has one continuous wide seal for each handle seal 928 and 930. FIG. 9 shows handle seal 928 having a straight upper seal edge 928a and a curved lower seal edge 928b for handle 162. FIG. 9 also shows handle seal 930 having a straight upper seal edge 930a and a curved lower seal edge 930b for handle 164.

As shown in FIG. 9, lower seal edges 928b and 930b have a radius of curvature centered above upper edges 112 and 114 of handles 162 and 164. Additionally, the radius of curvature of seal edges 928b and 930b of bag 900 exceeds the width of handles 162 and 164 of bag 900. As shown, each radius of curvature of lower handle seals 928b and 930b is centered between opposing sides of its corresponding handle 162 or 164. However, in further embodiments, the radius of curvature may be offset from the corresponding handle 162 or 164. Additionally, in further embodiments the radius of curvature of lower handle seals 928b and 930b may be less than the width of either one of the handles 162 and 164.

In at least certain embodiments, the minimum distance between upper and lower handles seals of handle 162 or 164 can be at least 1/16 of the width of the handle. In the same embodiment, the distance between the center of one of the handle's lower seals and the center of one of the handle's upper seals can be about ⅛ of the width of one of the handles 162 or 164 of bag 900. At least for certain sizes of T-shirt bags and as a non-limiting example, the shortest distance between upper and lower handle seals of a handle of bag 900 can be about ⅛ of an inch and the height between center of the upper and lower handle seals can be at least ¼ of an inch. These distances, however, can vary considerably depending upon the overall size of T-shirt bag 900.

As discussed above in regards to bag 800, bag 900 with lower handle seals 928b and 930b having a curvature as shown and described is advantageous by relocating the stress concentrations from the inside and outside edges of handles 162 and 164 to the center of handles 162 and 164. Handle seals 928 and 930 having a wide continuous sealed area of bag 900 can be advantageous over the dual seal arrangement of bag 800 by providing a greater seal area to spread the load stress and therefore reduce any stress concentrations.

In a typical manufacturing process, each solid handle seal 928 and 930 will be made by one continuous sealing surface. In certain embodiments, each sealing surface may have a temperature gradient extending on its surface between its upper and lower edges. For instance, a lower side of the sealing surface that defines lower seal edge 928b or 930b can have a lower temperature than an upper side of the sealing surface that defines upper seal edge 928a or 930a. Such a temperature gradient can be advantageous for certain manufacturing conditions where the sealing temperature has a tendency to be inconsistent. Such a temperature gradient provides for a greater likelihood that a proper seal will be made at least at a certain height between the upper and lower sealing edges of handle seals 928 and 930. For at least certain embodiments, this temperature gradient may be between ten and thirty degrees Fahrenheit.

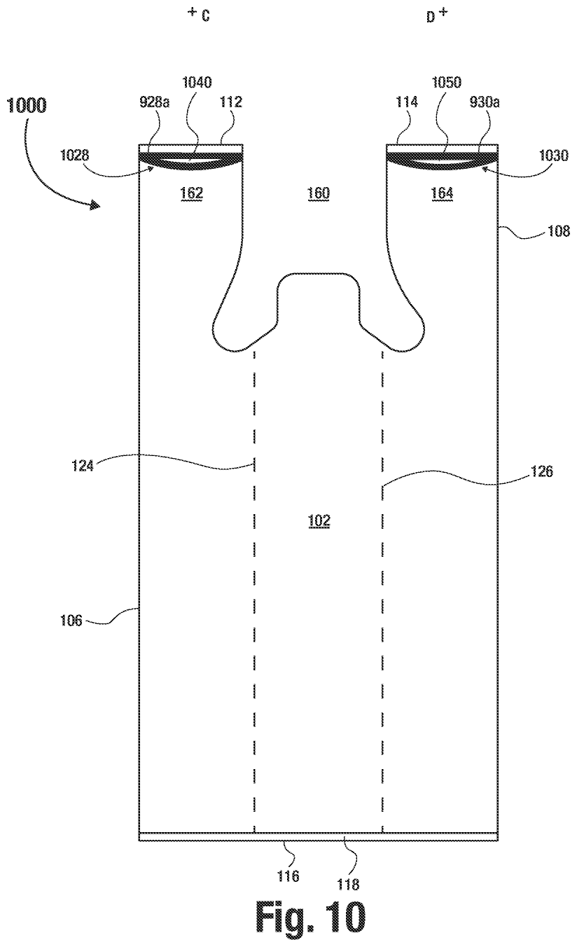

Bag 1000, shown in FIG. 10, is similar in structure to bag 900 of FIG. 9. However, instead of the entire area between upper and lower edges of handles seals 928 and 930 comprising a seal as bag 900, bag 1000 has an unsealed area or unsealed pocket 1040 and 1050 defined within each handle seal area 1028 and 1030. As shown by FIG. 10, the contours of unsealed areas 1040 and 1050 follow the outer contours of handle seals 1028 and 1030. However, in further embodiments, unsealed areas may have a shape that is dissimilar to that of the outline of handle seals 1028 and 1030.

Seal pockets 1040 and 1050 in bag 1000 can be advantageous to limit the amount of heat required to form handle seals 1028 and 1030 and to better regulate the temperatures of the seal blocks/sealing surfaces used in a manufacturing process to form handle seals 1028 and 1030. Use of pockets 1040 and 1050 can also assist in eliminating or limiting the formation of bubbles in handle seals 1028 and 1030 by limiting the area of the two seals and providing an additional area for air to evacuate from the various layers of film sealed together by handle seals 1028 and 1030.

As previously noted, the specific embodiments depicted herein are not intended to limit the scope of the present invention. Indeed, it is contemplated that any number of different embodiments may be utilized without diverging from the spirit of the invention. Therefore, the appended claims are intended to more fully encompass the full scope of the present invention.

What is claimed is:

1. A bag formed from a gusseted tube of polymeric film, the bag comprising:
a front panel and a rear panel, each panel having an upper edge and a bottom edge, the front and rear panel joined by a bottom seal adjacent to the bottom edge,
a first side gusset and a second side gusset, each side gusset between and on opposing sides of the front and rear panels, each side gusset comprising an inner fold and two outer folds, each side gusset comprising two layers between the two outer folds,
opposing first and second handles along the upper edges of the front and rear panels, the first and second handles separated from each other by a bag cutout,
the first handle comprising the front panel, the rear panel, the first side gusset, an upper handle seal and a lower handle seal,
the upper and lower handle seals sealing together the front panel, the rear panel, and the first side gusset, the upper and lower handle seals extending from a first side to an opposing second side of the first handle, the upper and lower handle seals at least twice as thick as the bottom seal,
wherein the upper and lower handle seals are separated by a width of unsealed film, the width of unsealed film extending continuously and uninterrupted between the upper and lower handle seals and the first and second sides of the first handle, and
a distance of the width of unsealed film between the upper and lower handle seals less than one-tenth a length of the bag, the length of the bag extending from the upper edge to the bottom edge of the front panel.

2. The bag of claim 1 further comprising:
the upper and lower handle seals generally straight.

3. The bag of claim 2 further comprising:
the upper and lower handle seals parallel with each other.

4. The bag of claim 3 further comprising:
the upper and lower handle seals separated from each other by at least ⅛ of an inch.

5. (canceled)

6. The bag of claim 1 further comprising:
the lower handle seal arcuate with a radius of curvature centered above the upper handle seal.

7. The bag of claim 1 further comprising:
the lower and upper handle seals comprising heat seals.

8. The bag of claim 7 further comprising:
the lower handle seal formed at a lower sealing temperature than the upper handle seal.

9. A bag formed from a gusseted tube of polymeric film, the bag comprising:
a front panel and a rear panel, each panel having an upper edge and a bottom edge, the front and rear panel joined by a bottom seal adjacent to the bottom edge,
a first side gusset and a second side gusset, each side gusset between and on opposing sides of the front and rear panels, each side gusset comprising an inner fold and two outer folds, each side gusset comprising two layers between the two outer folds,
opposing first and second handles along the upper edge, the first and second handles separated from each other by a bag cutout,
the first handle comprising the front panel, the rear panel, and the first side gusset,
a first handle seal sealing together the front panel, the rear panel, and the first side gusset,
the first handle seal comprising upper and lower opposing seal edges,
the upper seal edge generally, straight, parallel and proximate to the upper edge,
the lower seal edge arcuate with a radius of curvature above the upper edge, a center of the radius of curvature centered between first and second sides of the first handle,
the first handle seal extending continuously from first to second sides of the first handle and
a seal void defined within the first handle seal, the seal void comprising an area where the front panel, the rear panel, and the first side gusset are not sealed to each other,
wherein the lower seal edge intersects the upper seal edge in at least two locations such that the first handle seal defines a perimeter around the seal void.

10-11. (canceled)

12. The bag of claim 9 further comprising:
the radius of curvature a single constant radius having a length greater than a width of the first handle.

13. (canceled)

14. The bag of claim 12 further comprising:
an upper edge of the seal void parallel to the upper seal edge and a lower edge of the seal void parallel to the lower seal edge.

15. The bag of claim 12 further comprising:
the first handle seal comprising a heat seal, wherein the heat seal proximate to the lower seal edge is formed at a lower temperature than the heat seal formed proximate to the upper seal edge.

16-20. (canceled)

21. A bag formed from a gusseted tube of polymeric film, the bag comprising:
a front panel and a rear panel, each panel having an upper edge and a bottom edge, the front and rear panel joined by a bottom seal adjacent to the bottom edge,
a first side gusset and a second side gusset, each side gusset between and on opposing sides of the front and rear panels, each side gusset comprising an inner fold and two outer folds, each side gusset comprising two layers between the two outer folds,
opposing first and second handles along the upper edges of the front and rear panels, the first and second handles separated from each other by a bag cutout,
the first handle comprising the front panel, the rear panel, the first side gusset, an upper handle seal and a lower handle seal,
the upper and lower handle seals sealing together the front panel, the rear panel, and the first side gusset, the upper and lower handle seals extending continuously from a first side to an opposing second side of the first handle,
the lower handle seal having a radius of curvature centered above the upper handle seal such that from a top of the bag the lower handle seal is concave,
the lower handle seal intersecting the upper handle seal in two locations such that the upper and lower handle seals define a perimeter,
the upper and lower handle seals separated by a width of unsealed film at a central location between the first and second sides of the first handle, the width of unsealed film extending continuously and uninterrupted between the upper and lower handle,
the upper and lower seals at least twice as thick as the bottom seal, and
a distance of the width of unsealed film between the upper and lower handle seals less than one-tenth a length of the bag, the length of the bag extending from the upper edge to the bottom edge of the front panel.

22. The bag of claim 21 further comprising:
the upper handle seal formed at a higher temperature than the lower handle seal.

23. The bag of claim 1 further comprising:
the upper and lower seals intersecting each other to form a perimeter.

24. The bag of claim 9 further comprising:
the first handle seal more than four times as thick as the bottom seal.
